(19) United States
(12) Patent Application Publication
(10) Pub. No.: US 2023/0373822 A1
(43) Pub. Date: Nov. 23, 2023

(54) COMPACT ULTRAVIOLET FLUID DISINFECTION DEVICE AND METHOD

(71) Applicant: Pentair, Inc., Minneapolis, MN (US)

(72) Inventor: Anuj Saini, Roorkee (IN)

(21) Appl. No.: 18/247,022

(22) PCT Filed: Sep. 28, 2021
(86) PCT No.: PCT/US2021/071624

§ 371 Date: Mar. 28, 2023

Related U.S. Application Data
(60) Provisional application No. 63/084,355, filed on Sep. 28, 2020.

(51) Int. Cl. C02F 1/32

(52) U.S. Cl. CPC C02F 1/325; C02F 2201/3222; C02F 2201/3228; C02F 2201/328

(57) ABSTRACT

A device for disinfecting a fluid includes a first casing and a second casing. Each casing includes at least one source of UV radiation. A fluid passage is provided between the first casing and the second casing. The UV radiation emitted from the at least one source of UV radiation of the first casing is emitted in a first direction toward the fluid passage. The UV radiation emitted from the at least one source of UV radiation of the second casing is emitted in a second direction toward the fluid passage. The first direction is different than the second direction.

### TECHNICAL FIELD

This present invention generally relates to a compact device and a method for fluid disinfection using ultraviolet (UV) radiation. More particularly, the present invention relates to a UV disinfection device and method operating with one or more ultraviolet light emitting diodes (UV-LEDs).

### BACKGROUND

One of the main applications of ultraviolet (UV) radiation is water disinfection. Ultraviolet rays can kill microorganisms, viruses, bacteria, molds, and fungus. UV light is a portion of the electromagnetic spectrum between X-rays and visible light. UV wavelengths lie between 100 nanometer (nm) to 400 nm. The UV spectrum is further divided into UV-C (100-280 nm), UV-B (280-315), and UV-A (315-400 nm).

It has been found that viruses and microorganisms are readily destroyed when exposed to UV radiation. The UV radiation, and particularly UV-C radiation, kills viruses and microorganisms by damaging the genetic information (e.g., DNA, RNA). If the damage is severe enough, the virus or microorganism cannot repair and will die. UV disinfection leaves no residual chemical or radiation. When UV radiation is used to disinfect water, no residual chemicals or radiation are found in the water, though a minimum exposure time and optimum intensity are required.

UV treatment generally takes place inside a specialized UV exposure chamber. Conventional fluid disinfection devices use low and medium pressure UV mercury lamps as the source of UV radiation. UV mercury lamps emit UV-C radiations to kill viruses and germs present inside liquid. These UV mercury lamps are glass tube structures and generally fragile, occupy large space, require high voltage, are high power and generate significant heat. These properties limit the application in small sized, low powered UV disinfection modules.

With recent advancement in Light Emitting Diode (LED) technology, LEDs can be designed to generate UV radiation at desired wavelengths. The UV light emitted by UV-LEDs with a wavelength of 250 nm to 300 nm has a good sterilization and disinfection effect.

UV-LEDs have many advantages as compared to traditional UV mercury lamps. UV-LEDs are smaller in size, require lower voltage and generate less heat. UV-LEDs are also generally more robust, durable and efficient compared to traditional UV mercury lamps. UV-LEDs also have the ability to turn on and off with high frequency. These advantages provide opportunity for the use of UV-LEDs in fluid disinfection.

Existing UV-LED disinfecting technologies strive to realize the benefits of UV-LEDs, but fall short by utilizing complex and large structures. Other UV-LED disinfecting technologies face obstacles such as loss of effectiveness/efficiency in low turbidity fluids, low UV exposure times, and obstruction between the UV radiation source and the fluid. For example, existing straight devices for disinfection of fluid using UV-LEDs have a single inlet and single outlet, with the fluid passing the UV-LED or UV-LED plate in a straight path. As a result, the exposure time is either very short, which is inefficient for fluid disinfection, or the device must be very long. Other existing devices utilize an out-and-back approach using a single UV-LED or single UV-LED plate at the turn-around point. The resulting devices are smaller in size than the straight flow path devices, but the fluid's UV exposure time is minimal. The UV dosing is also non-uniform in such devices. Accordingly, the art recognizes the need for a compact and efficient UV module for fluid disinfection which overcomes one or more of the recited limitations.

### SUMMARY

In an embodiment, the present disclosure provides a device for disinfecting a fluid. In accordance with embodiments of the present disclosure, the device for disinfecting fluid comprises a first casing including a first at least one source of UV radiation, a second casing including a second at least one source of UV radiation, and a fluid passage provided in between the first casing and the second casing. The UV radiation emitted from the first at least one source of UV radiation is directed toward the fluid passage from a first direction and UV radiation emitted from the second at least one source of radiation is directed toward the fluid passage from a second direction that is different from the first direction.

In accordance with another embodiment, the fluid passage is provided in the form of a circular spiral fluid passage, a triangular spiral fluid passage, an hexagonal spiral fluid passage, a pentagonal spiral fluid passage, an octagonal spiral passage, or a rectangular spiral fluid passage.

In yet another embodiment, the first at least one source of UV radiation and the second at least one source of UV radiation are UV-LEDs. In a further embodiment, the first casing further comprises a first printed circuit board (PCB) including the first at least one source of UV radiation, and the second casing further comprises a second PCB including the second at least one source of UV radiation. In another embodiment, the device further comprises a first reflection plate provided between the first casing and the fluid passage, and a second reflection plate between the second casing and the fluid passage. In still another embodiment, the device further comprises a first heat sink coupled to an outer surface of the first casing and a second heat sink coupled an outer surface of the second casing.

In accordance with further embodiments, an inner surface of the first casing comprises a UV-reflective finish and an inner surface of the second casing comprises a UV-reflective finish.

In further embodiments, the first casing further comprises an inlet connected to the fluid passage, and the second casing further comprises an outlet connected to the fluid passage, wherein the fluid enters the fluid passage from the inlet, passes through the fluid passage, and exits the fluid passage via the outlet. In an embodiment, the inlet is connected to the fluid passage at a central portion of the fluid passage.

In another embodiment, the UV radiation emitted from the first at least one source of UV radiation and the UV radiation emitted from the second at least one source of UV radiation each have a wavelength between about 265 nanometer (nm) to about 280 nm. In still a further embodiment, the first at least one source of UV radiation comprises one or more UV LEDs of 10-500 milliwatt (mW) each and placed approximately 20 millimeter (mm) to 40 mm apart from each other above the fluid passage.

In an embodiment, the fluid is water.

In an embodiment, the present disclosure provides a device for disinfecting fluid. In accordance with embodiments of the present disclosure, a device for disinfecting fluid comprises a first casing including a first plurality of UV-LEDs configured to emit UV radiation, a second casing including a second plurality of UV-LEDs configured to emit UV radiation, a fluid passage configured to accept a fluid provided in between the first casing and the second casing, a first reflection plate between the first casing and the fluid passage, a second reflection plate between the second casing and the fluid passage, an inlet coupled to the first casing and is further connected to a first end of the fluid passage, and an outlet coupled to the second casing and is further connected to a second end of the fluid passage. A fluid enters through the inlet, passes through the fluid passage, and exits through the outlet, and the UV radiation from the first plurality of UV-LEDs is directed toward the fluid passage from a first direction and the UV radiation from the second plurality of UV-LEDs is directed toward the fluid passage from a second direction that is opposite from the first direction.

In an embodiment, the fluid passage is a circular spiral fluid passage, a triangular spiral fluid passage, an hexagonal spiral fluid passage, a pentagonal spiral fluid passage, an octagonal spiral passage, or a rectangular spiral fluid passage.

In an embodiment, the present disclosure provide a method of disinfecting a fluid. In accordance with embodiments of the present disclosure, a method for disinfecting fluid comprises providing a fluid to be disinfecting through a fluid passage, providing UV radiation from a first at least one source of UV radiation, wherein the UV radiation is emitted in a first direction onto the fluid passage, and providing UV radiation from a second at least one source of UV radiation, wherein the UV radiation is emitted in a second direction on the fluid passage, wherein the first direction is opposition from the second direction.

In an embodiment, the UV radiation from each of the first and second at least one sources of UV radiation has a wavelength between about 265 nm to about 280 nm. In another embodiment, the fluid passage is a circular spiral fluid passage, a spiral triangular fluid passage, a hexagonal spiral fluid passage, a pentagonal spiral fluid passage, an octagonal spiral fluid passage, or a rectangular spiral fluid passage.

### DESCRIPTION OF THE DRAWINGS

FIG. 1 illustrates an isometric view of a UV disinfection device according to an embodiment;

FIG. 2 illustrates a schematic diagram of the device of FIG. 1;

FIG. 3 illustrates a partially diagrammatic perspective view of a spiral fluid flow passage according to an embodiment;

FIG. 4 illustrates a top view of the spiral fluid passage;

FIG. 5 illustrates a cross-sectional view of a spiral flow UV disinfection device according to an embodiment;

FIG. 6 illustrates an exploded view of a spiral flow UV disinfection device according to an embodiment;

FIG. 7 illustrates a schematic diagram of a spiral flow UV disinfection device;

FIG. 8 illustrates a UV dose variation inside the fluid flow passage;

FIG. 9 illustrates a flow velocity pattern inside the fluid flow passage;

FIG. 10 illustrates a partially diagrammatic view of a plurality of UV LEDs located in a spiral UV disinfection device;

FIG. 11 illustrates a partially diagrammatic perspective view of a spiral fluid flow fluid passage;

FIG. 12 illustrates a cross section view of the spiral fluid flow passage;

FIG. 13 illustrates a partially diagrammatic perspective view of the spiral fluid flow passage geometry;

FIG. 14 illustrates a partially diagrammatic view of various baffle shapes that may be provided inside the spiral fluid flow fluid passage;

FIG. 15 illustrates a partially diagrammatic view of various spiral quartz flow passages geometry;

FIG. 16 illustrates a perspective view of a spiral flow passage in parallel combination;

FIG. 17 illustrates a perspective view of a spiral flow passage in series combination;

FIG. 18A illustrates a partially diagrammatic perspective view of an alternate flow passage of UV disinfection module;

FIG. 18B illustrates a partially diagrammatic perspective view of an alternate flow passage of a UV disinfection module;

FIG. 18C illustrates a partially diagrammatic perspective view of an alternate flow passage of a UV disinfection module;

FIG. 18D illustrates a partially diagrammatic perspective view of an alternate flow passage of a UV disinfection module;

FIG. 18E illustrates a partially diagrammatic cross-sectional perspective view of an alternate flow passage of a UV disinfection module;

FIG. 19 illustrates a method flow diagram for disinfecting fluid;

FIG. 20 illustrates UV LEDs placement for disinfecting fluid; and

FIG. 21 illustrates UV LEDs placement for disinfecting fluid according to another embodiment.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

It is to be understood that the phraseology and terminology used herein is for the purpose of description and should not be regarded as limiting. The use of “including” “comprising, ” or “having” and variations thereof herein is meant to encompass the items listed thereafter and equivalents thereof as well as additional items. That is, the terms “comprising” “including, ” “having, ” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term, “consisting essentially of” excludes from the scope of any succeeding recitation any other component, step, or procedure, excepting those that are not essential to operability. The term “consisting of” excludes any component, step, or procedure not specifically delineated or listed. The term “or, ” unless stated otherwise, refers to the listed members individually as well as in any combination. Use of the singular includes use of the plural and vice versa.

Unless specified or limited otherwise, the terms “mounted, ” “connected, ” “supported, ” and “coupled” and variations thereof are used broadly and encompass both direct and indirect mountings, connections, supports, and couplings. Further, “connected” and “coupled” are not restricted to physical or mechanical connections or couplings.

As used herein, the term “fluid” refers to any liquid or gas fluid, including but not limited to water, oil, organic liquids, inorganic liquids, air, gases, and combinations thereof.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

A device for disinfecting a fluid, such as water, is provided. The device comprises a first casing including a first at least one source of UV radiation, a second casing including a second at least one source of UV radiation, and a fluid passage provided in between the first casing and the second casing. UV radiation emitted from the first at least one source of UV radiation is directed toward the fluid passage from a first direction, and UV radiation emitted from the second at least one source of radiation is directed toward the fluid passage from a second direction that is different from the first direction.

A device for disinfecting fluid is provided. The device comprises a first casing including a first plurality of UV-LEDs configured to emit UV radiation, a second casing including a second plurality of UV-LEDs configured to emit UV radiation, a fluid passage configured to accept a fluid provided in between the first casing and the second casing, a first reflection plate between the first casing and the fluid passage, a second reflection plate between the second casing and the fluid passage, an inlet coupled to the first casing and is further connected to a first end of the fluid passage, and an outlet coupled to the second casing and is further connected to a second end of the fluid passage. A fluid enters through the inlet, passes through the fluid passage, and exits through the outlet, and the UV radiation from the first plurality of UV-LEDs is directed toward the fluid passage from a first direction and the UV radiation from the second plurality of UV-LEDs is directed toward the fluid passage from a second direction that is opposite from the first direction.

A method of disinfecting fluid is provided. The method comprises the steps of providing a fluid to be disinfecting through a fluid passage, providing UV radiation from a first at least one source of UV radiation, wherein the UV radiation is emitted in a first direction onto the fluid passage, and providing UV radiation from a second at least on source of UV radiation, wherein the UV radiation is emitted in a second direction on the fluid passage, wherein the first direction is opposite from the second direction.

Referring now to FIG. 1, an isometric view of a UV disinfection device 15 according to an exemplary embodiment is shown. As can be seen, the UV disinfection device 15 comprises an inlet 1′ from where fluid (such as water) enters the UV disinfection device 15 and an outlet 5′ through which the fluid exits the UV disinfection device 15. In an embodiment, a fluid, and more particularly a fluid assumed to have, or having, viruses and/or bacteria and/or other microorganisms, etc. (referred to collectively herein as “infectious impurities”) enters the inlet 1′. The fluid circulates inside the UV disinfection device 15, the UV disinfection device 15 disinfects the fluid, and the fluid, now substantially free, or free, from the infectious impurities exits from the outlet 5′ of the UV disinfection device 15.

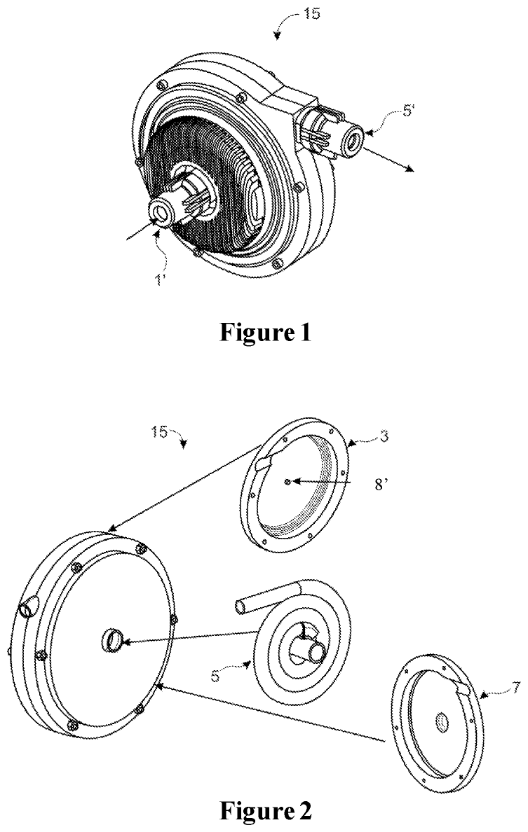

FIG. 2, a schematic diagram of the device 15 of FIG. 1, illustrates the UV disinfection device 15 in further detail. A first casing 3, a spiral fluid passage 5, and a second casing 7 are provided in the UV disinfection device 15. The first casing 3 covers the spiral fluid passage 5 from one end and the second casing 7 covers the spiral fluid passage 5 from another end. Further, the first casing 3 has at least one source of UV radiation 8′ placed in a center of the first casing 3 to disinfect the fluid through its emitted radiation.

In an embodiment, at least a portion, or preferably all internal surfaces of the first casing 3 and the second casing 7 have mirror-like or mirrored polish, coating or surface treatment.

In the embodiment shown, the spiral fluid passage 5 is provided as a circular spiral; however, other possible shapes (such as a triangle, a rectangle, a square, a pentagonal, a hexagonal, an octagonal etc.) of the spiral fluid passage are also within the scope of this present disclosure.

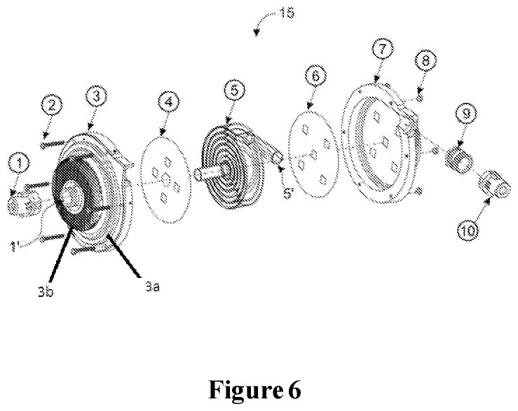

The spiral fluid passage 5 is designed to be made of a material which permits the passage of UV radiation therethrough to contact the fluid flowing through the passage 5. In some embodiments, the spiral fluid passage 5 is provided in the form of a transparent or translucent material, and preferably a transparent material. In some embodiments, the spiral fluid passage 5 is a quartz transparent tube in a coil shape. Quartz glass is ideal for its optical transmission, i.e., UV radiation easily passes through quartz glass. Further details of the first casing 3, the spiral fluid passage 5 and the second casing 7 are provided in FIG. 6 below.

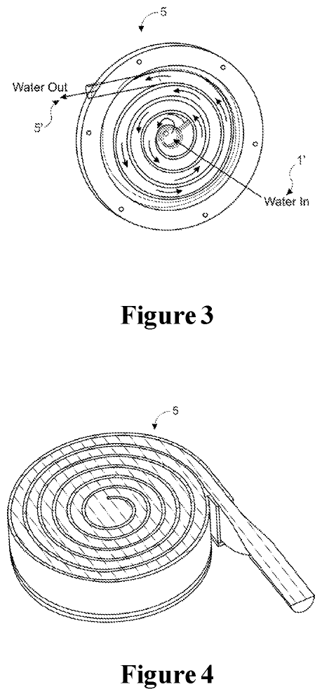

Referring now to FIG. 3, a partially diagrammatic perspective view of a spiral fluid flow passage 5 is shown according to an embodiment, with FIG. 4 illustrating a top view rectangular cross section of a spiral fluid flow passage 5. Inside the spiral fluid passage 5, a fluid flow path using arrows inside the spiral fluid passage 5 is shown. In particular, the fluid enters from the inlet 1′. The inlet 1′ is provided in a substantially perpendicular orientation with respect to the plane of the spiral fluid passage 5 and creates an axis around which the spiral fluid passage 5 winds. The fluid travels though the spiral fluid passage 5, where the fluid is treated with UV radiation, and then exits from the outlet 5′. The outlet 5′ is provided tangential from the spiral of the spiral fluid passage 5. The fluid flow path is shown by the arrows.

In an embodiment, the spiral fluid passage 5 winds about the axis created by the inlet at least more than one time, and preferably at least 1.5×, or 2×, or 2.5×, or 3×, or 3.5×, or 4×, or 4.5×, or 5×, or 5.5×, or 6×, or 6.5×, or 7×. In a particular embodiment, the spiral fluid passage 5 winds about the axis created by the inlet from greater than 1×, or 1.25×, or 1.5×, or 1.75×, or 2×, or 2.25×, or 2.5×, or 2.75×, or 3×, or 3.25×, or 3.5×, or 3.75× to 4×, or 4.25×, or 4.5×, or 4.75×, or 5×, or 5.25×, or 5.5×, or 5.75×, or 6×.

It will be appreciated that increasing the number of revolutions, or number of times the spiral fluid passage 5 winds about the axis, increases the overall fluid flow length through the device 15. Increasing the fluid flow length will increase the capacity (volume) of the device 15 as well as provide a long UV exposure time for the fluid. The capacity (volume) of the device 15 will also increase as the diameter or width of the spiral fluid passage 5 increases. It is therefore also appreciated that to decrease the overall capacity (volume) of the device, the number of revolutions of the spiral fluid passage 5 may be decreased and/or the diameter or width of the spiral fluid passage 5 may be decreased.

Because the disinfecting function of UV radiation is dependent on exposure of the fluid to the UV radiation, the device's 15 ability to disinfect a fluid is dependent on how long the fluid is contained in the device in the presence of the UV radiation and how intense the radiation is. Given a consistent flow path length, a lower flow rate and a high intensity UV all contribute to improved efficiency of a device 15 compared to a device with a higher flow rate and lower intensity UV.

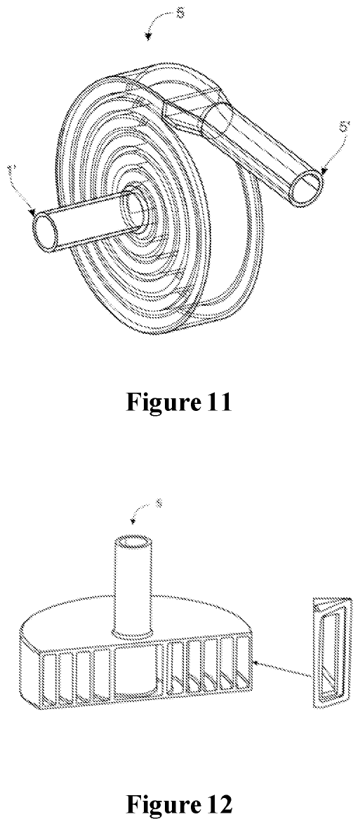

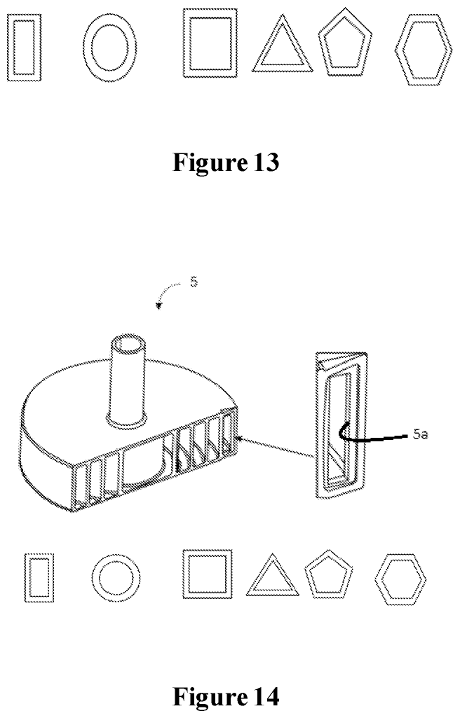

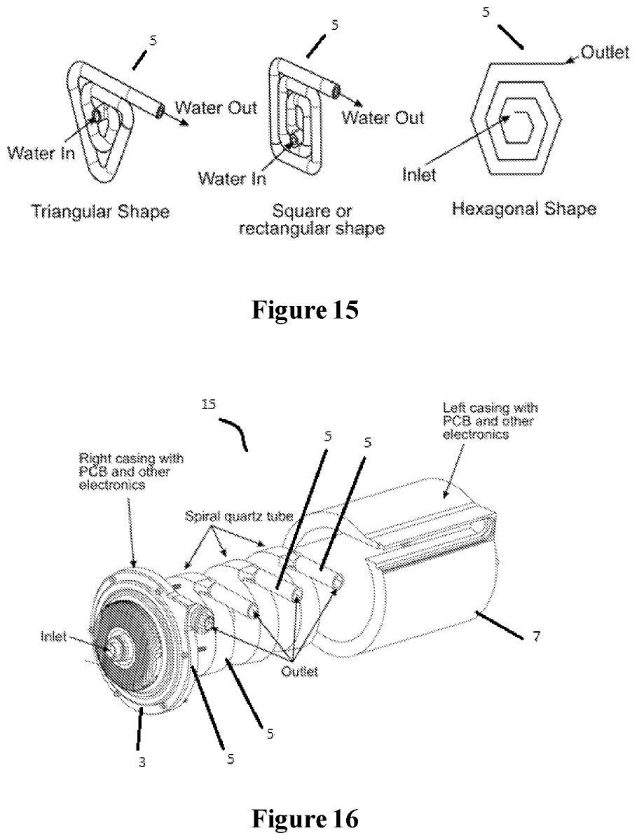

FIGS. 11 and 12 illustrate the spiral fluid passage 5 in further detail. In particular, the spiral fluid passage 5 has a rectangular cross section along the length of its flow path. In other embodiments, the spiral fluid passage 5 may have a different cross sectional shape, such as shown in FIG. 13, including but not limited to, rectangular, ovular, circular, square, triangular, pentagonal, hexagonal, or other polygon. In still further embodiments, the cross sectional shape of the spiral fluid passage 5 may change along the length of the flow path.

FIG. 14 illustrates an alternative embodiment of a spiral fluid passage 5 in which the spiral fluid passage 5 includes one or more baffles 5a. In the embodiment shown, the baffles 5a are provided in a rectangular orientation to match the cross-sectional profile of the spiral fluid passage. However, in other embodiments, the baffles may take any shape, including shapes which match the cross-sectional shape of the spiral fluid passage or not, and including but not limited to rectangular, ovular, circular, square, triangular, pentagonal, hexagonal, and other polygonal shapes.

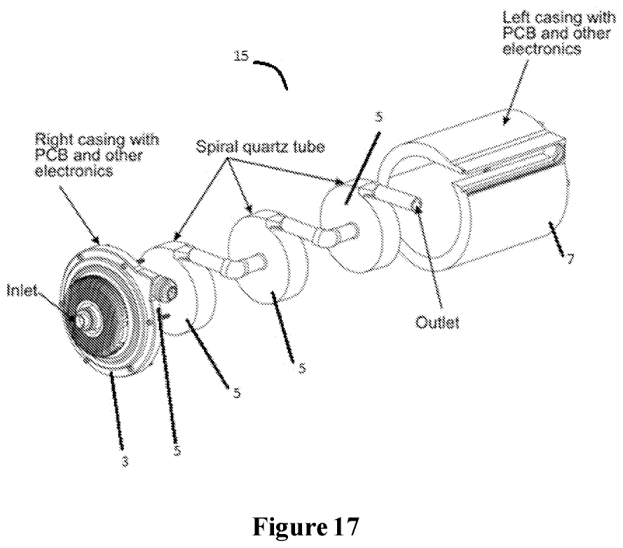

In the embodiments of the spiral fluid passage 5 illustrated until now, the spiral itself has been circular, or approximately circular. That is, the fluid passage is wound about an axis to create a circular spiral fluid passage 5. In other embodiments, and as shown in FIG. 17, the spiral may be other than a circular spiral, including but not limited to a triangular spiral, a square spiral, a rectangular spiral, a pentagonal spiral, a hexagonal spiral, and an octagonal spiral.

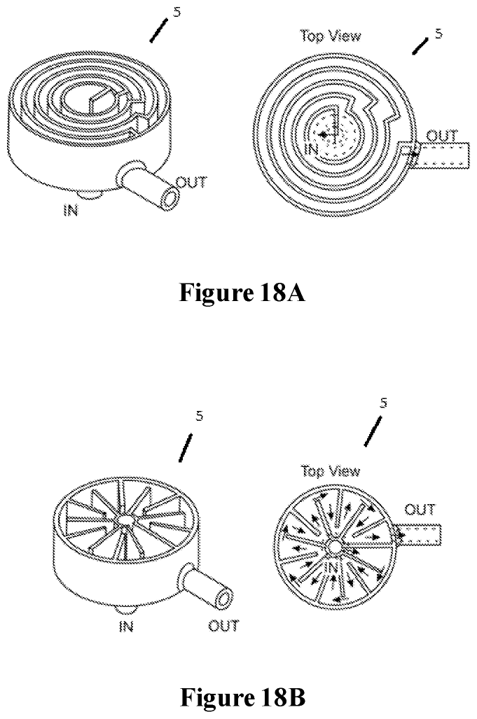

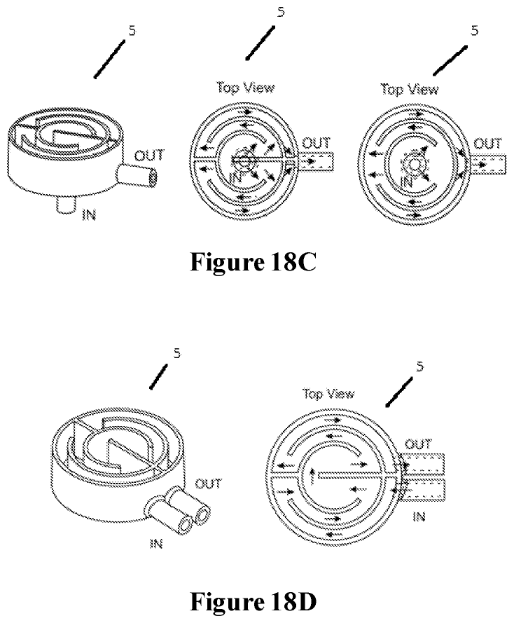

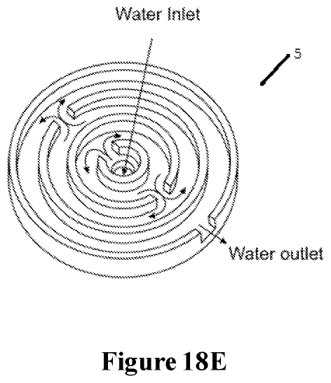

The fluid flow passage inside UV module casing can have different fluid flow patterns as shown in FIGS. 18A, 18B, 18C, 18D, 18E. Fluid can travel in one or more flow paths within the circular inner walls with constant width inner channel or partition. Different types of flow paths can be made by creating partitions with the UV module casing. These alternate fluid flow passage casings can have one fluid inlet from the center and one fluid outlet from the tangential end of UV module casing. The fluid inlet can be perpendicular to the fluid outlet

FIGS. 18A-18E illustrate further alternative embodiments of a spiral fluid passage. In the embodiment shown in FIG. 18A, the fluid moves in an outward spiral, but with a baffle wall disposed at each complete revolution. In FIG. 18B, the fluid enters the spiral fluid passage at the center, and the fluid moves axially away from and then towards the central axis as the flow spirals about the axis. In FIG. 18C, the fluid is divided into two flow paths upon entry to the spiral fluid passage and flows in accordance with the arrows provided in FIG. 18C. FIG. 18D is very similar to FIG. 18C in that the fluid is divided in two portions. However, unlike FIG. 18C, the embodiment shown in 18D is lacking the additional internal structures which would otherwise prevent the two portions from contacting one another.

In the embodiment shown in FIG. 18D, the inlet and outlet are adjacent, that is, both the inlet and the outlet are at the periphery of the spiral fluid passage 5. Flow through the spiral fluid passage 5, however, remains substantially in a spiral fashion, as indicated by the arrows in FIG. 18D.

FIG. 18E illustrates a further exemplary embodiment of a spiral fluid passage 5 in which the fluid still proceed about the axis but with the opportunity for partially or fully disinfected fluid to intermingle during the process.

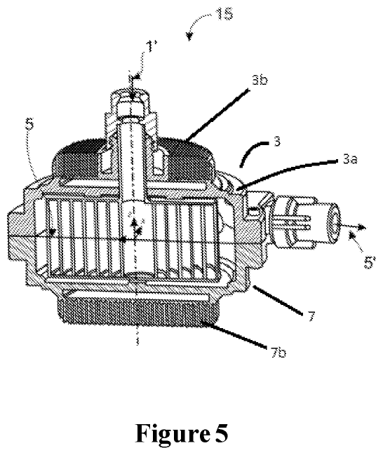

Referring now to FIGS. 5 and 6, a cross-sectional view of a UV disinfection device 15 and an exploded view, respectively, are shown. The inlet 1′, outlet 5′ and spiral fluid passage 5 can be seen. An inlet fitting 1 holds and connects an inlet water line with the rest of the UV disinfection device 15 without leakage. An outlet thread connector 9 can connect an outlet fitting 10 with the remaining assembly. The outlet fitting 10 can hold and connect the outlet water line with rest of the spiral UV reactor assembly without leakage.

In the embodiment shown, the first casing 3 makes an enclosure with the second casing 7 to encase the spiral fluid passage 5. At least one holding bolt 2 and nut 8 can be used to secure the overall device 15. In the embodiment shown, six bolt 2/nut 8 pairs are used to secure the first casing 3 and second casing 7 to one another and hold the device together. However, in further embodiments, different numbers of bolt/nut pairs may vary depending on size, shape, and material of the device, and particularly the first casing 3 and second casing 7. Moreover, other securing structures, devices or assemblies may be used to secure the overall device, including, but not limited to, braces, brackets, clips, interlocking contours, friction fit component/contours, latches, hooks, clamps, and combinations of these another such structures, devices and assemblies. In still further embodiments, a gasket may be provided between the first casing 3 and second casing 7.

In an embodiment, the first casing 3 includes at least one source of UV radiation (not visible in FIGS. 5 and 6) and printed circuit board (PCB) or other electronic components operatively coupled with the source of UV radiation which facilitate and allow the UV radiation source to function. The source of UV radiation can be provided in the form of at least one UV lamp, UV-LED, semiconductor, or any other type of UV source. It is preferred that the light source is a UV-LED or a semiconductor, and more preferable a UV-LED.

In an embodiment, there is one, or two, or three, or four, or five, or more than five sources of UV radiation, and particularly UV-LEDs and/or semiconductors. In a particular embodiment, the first casing 3 includes at least one, or one, or at least two, or two, or at least three, or three, or at least four, or four, or at least five, or five UV-LEDs operatively coupled with a PCB or similar electrical components.

In an embodiment, the at least one source of UV radiation includes a collimator.

As shown in FIG. 2, in an embodiment, the at least one source of UV radiation is located at an approximate center point of the inner face of the first casing 3. In other words, in an embodiment, the at least one source of UV radiation is aligned with the axis around which the spiral fluid passage 5 winds. In another embodiment, the at least one source of UV radiation may be offset relative to that axis. In still further embodiments, and particularly when more than one source of UV radiation is used, the sources of UV radiation are symmetrically arranged about the axis around which the spiral fluid passage 5 winds. In alternative embodiments in which more than one source of UV radiation is used, the sources of UV radiation are not symmetrically arranged about the axis around which the spiral fluid passage 5 winds.

In an embodiment, the at least one source of UV radiation emits radiation of a single wavelength. In other embodiments, the at least one source of UV radiation emits radiation of a range of wavelengths. When more than one source of UV radiation is provided, each source of UV radiation may independently emit the same single wavelength, different single wavelengths, the same range of wavelengths, or different ranges of wavelengths. In an embodiment, the at least one source of UV radiation is one or more UV-LEDs. The one or more UV-LEDs may emit radiation of a single wavelength or range of wavelengths.

UV wavelengths are generally considered between 100 nm and 400 nm. In an embodiment, the at least one source of UV radiation emits one or more radiation wavelengths between about 100 nm to about 400 nm. In an embodiment, the at least one source of UV radiation emits at least one of at least one wavelength from about 100 to about 280 nm (UV-C radiation), at least one wavelength from about 280 nm to about 215 nm (UV-B radiation), and at least one wavelength from about 315 nm to about 400 nm (UV-A radiation). In an embodiment, the at least one source of UV radiation emits at least one of (1) a UV-C radiation wavelength, (2) a UV-B radiation wavelength, and (3) a UV-A radiation wavelength. In a preferred embodiment, the at least one source of UV radiation emits one or more UV-C radiation wavelengths, and more preferably at least one wavelength from about 265 nm to about 280 nm.

In an embodiment, the at least one source of UV radiation is at least one UV-LED, and the at least UV-LED emits at least one of (1) a UV-C radiation wavelength, (2) a UV-B radiation wavelength, and (3) a UV-A radiation wavelength. In a preferred embodiment, the at least one UV-LED emits one or more UV-C radiation wavelengths, and more preferably at least one wavelength from about 265 nm to about 280 nm.

It was discovered that the fluid sterilization effect of UV radiation is maximized when using UV-C radiation wavelengths, and more specifically at wavelengths from 265 nm to 280 nm.

In an embodiment, UV radiation is provided perpendicular to, or substantially perpendicular to, or at an angle relative to the flow of fluid in the spiral fluid passage 5. The diameter or width of the spiral flow path is calculated specifically to permit opposite sides of the device, that is, the inner faces of the first casing 3 and second casing 7, to receive a target amount of UV radiation intensity, whether a maximum target intensity or a minimum intensity.

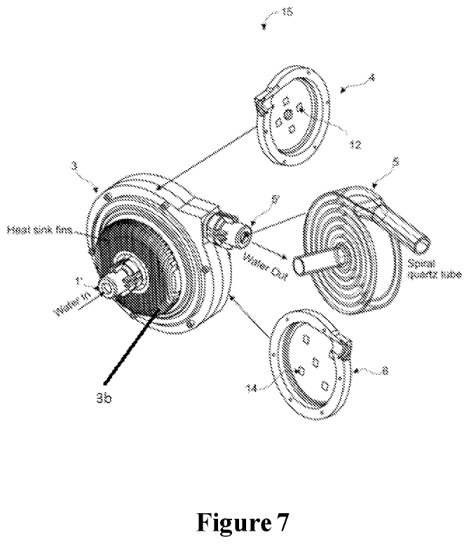

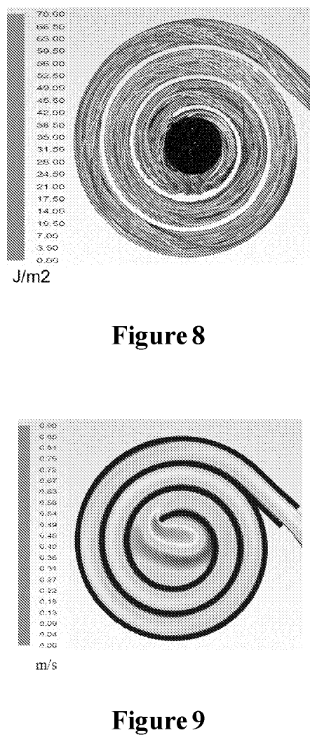

An outer face 3a of the first casing 3 can have fins 3b provided in the form of a heat sink, as shown in FIGS. 7 and 8. The fins are designed to dissipate heat generated by the at least one source of UV radiation during operation. An inner face of the first casing 3 can have a reflective, mirror-like or mirror finish or coating which reflects UV radiation. Exemplary UV reflective materials include expanded polytetrafluoroethylene (referred hereinafter as “ePTFE”) (Teflon), aluminum, electro polished stainless steel, and other materials with a high level of diffuse reflectance. In a particular embodiment, the UV reflective finish or coating is a finish or coating of ePTFE. The first casing 3 has one inlet 1′ at the center, through which fluid can enter the spiral fluid passage 5.

The second casing 7 makes the enclosure with the first casing 3 to encase the spiral fluid passage 5. In an embodiment, the second casing 7 also includes at least one source of UV radiation (not visible in FIGS. 7 and 8) and PCB or other electronic components operatively coupled with the source of UV radiation which facilitate and allow the UV radiation source to function. As with the first casing 3, the source of UV radiation can be at least one UV lamp, UV-LED, semiconductor or any other type of UV source. It is preferred that the light source is a UV-LED or semiconductor, and more preferably a UV-LED.

In an embodiment, the at least one source of UV radiation is in accordance with any embodiment or combination, or embodiments described with reference to the first casing 3 above.

The second casing 7 can also have a PCB or additional electronic components. The PCB can have at least one light source with or without a collimator lens facing toward the spiral fluid passage. An inner face of the second casing 7 can have a reflective, mirror-like or mirror finish or coating which reflects UV radiation. In an embodiment the UV reflective finish or coating is in accordance with any embodiment or combination of embodiments described with reference to the first casing 3 above.

In an embodiment, the second casing 7 can have fins 7b provided in the form of a heat sink, as shown in FIGS. 7 and 8. The fins can dissipate heat generated by the at least one source of UV radiation during operation.

In the embodiment shown, the first and second casings 3, 7 together with the spiral fluid passage 5 are in communication with the outlet 5′.

The spiral fluid passage 5 forms a central portion of the UV module. The UV radiation emitted by the at least one source of UV radiation passes through the spiral fluid passage 5 from opposite directions, that is, from the first casing side and the second casing side. The fluid can enter from a center of the spiral fluid passage 5. After circulation in the spiral flow passage, the fluid can exit from the outlet 5′ attached to the spiral fluid passage 5. During circulation, UV rays can disinfect the fluid to remove or reduce viruses, bacteria etc. in the fluid.

In an embodiment, the device may further include a first reflection plate 4 and/or a second reflection plate 6 to efficiently reflect the UV rays emitted by the at least one source of UV radiation. Reflecting the UV radiation within the device allows more of the UV radiation to be used for disinfection, and therefore results in improved efficiency and a better disinfection process.

For the UV radiation to disinfect fluids, the radiation must strike the target (e.g., fluid) with little to no obstruction. It was discovered that the use of a spiral fluid passage 5, at least one source of UV radiation positioned such that the radiation strikes the fluid perpendicular to, substantially perpendicular to, or at an angle relative to the fluid flow, and the reflective, mirror-like or mirror finish or coating on the inner surface of one or both of the first casing 3 and second casing 7 results in sufficient radiation exposure and intensity to disinfect a fluid, such as water, traveling through the spiral fluid passage 5. The simplified interior design of the device 15 limits or eliminates any obstructions between the at least one source of UV radiation and the fluid, resulting in higher, uniform intensity of UV radiation at any specific point along the spiral fluid flow path.

FIG. 7 illustrates an alternative embodiment of a UV disinfecting device 15. In particular, the device 15 in FIG. 9 shows the at least one source of UV radiation 12, 14 as being on the first reflection plate 4 and second reflection plate 6, respectively. Further, each of the at least one source of UV radiation 12, 14 is shown as four sources of UV radiation, and in particular four UV-LEDs. In such an embodiment, the device 15 can use a collimator lens to diverge or converge the UV radiation to get a desired disinfection output. The UV-LEDs, or other sources of UV radiation, can emit radiation at different angles, such as a narrow angle or a wide angle. A collimating lens refracts UV radiation from the source of the UV radiation with a certain spread and it transmits UV radiation. The UV radiation pattern can be modified by using the appropriate collimator lens.

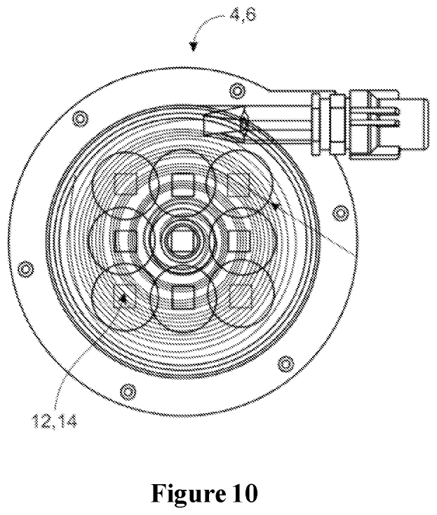

FIG. 10 illustrates a further alternative embodiment in which the device 15 as a whole includes 9 sources of UV radiation. In particular, the sources of UV radiation 12, 14 are divided such that five sources of UV radiation 12, 14 are on one of the first reflection plate 4 and second reflection plate 6, and the other four sources of UV radiation 12, 14 are on the other of the first reflection plate 4 and second reflection plate 6. By including a plurality of sources of UV radiation on each side of the spiral fluid path 5, the intensity of the UV radiation throughout the device and along the spiral fluid path 5 is more evenly applied along the fluid flow path.

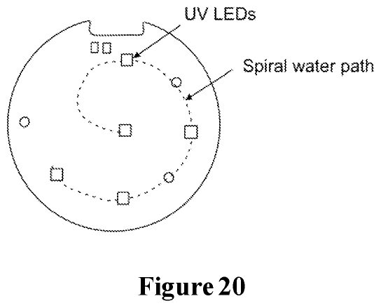

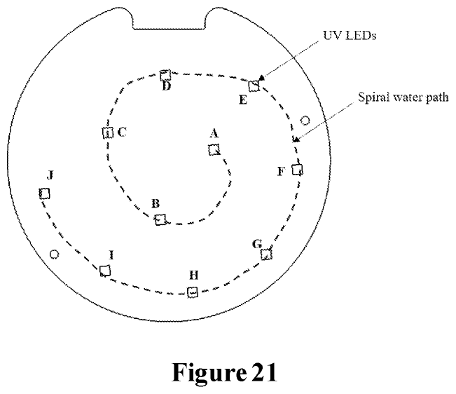

FIGS. 20 and 21 illustrate further alternative embodiments of a device 15 including different numbers and arrangements of sources of UV radiation, and particularly UV-LEDs. Referring to FIG. 20, five UV LEDs positioning for disinfecting fluid according to an exemplary embodiment are depicted. As can be seen, five UV LEDs (A, B, C, D and E) are placed on the casing. UV LED A is placed in the center of the casing, UV LED B is placed vertically above the UV LED A, and UV LED D is placed vertically below the UV LED A. UV LED C is placed to a right side of the UV LED A and UV LED E is placed left side downwards of the UV LED A. It is to be noted here that the placement of these five UV LEDs is important as their respective placement helps in disinfecting the fluid. Moreover, the water fluid flow spiral path is shown using the dotted lines in FIG. 22.

In some embodiments, the UV LEDs (A, B, C, D and E) Optical Power is 70 mW and the UV LEDs (A, B, C, D and E) wavelength is 265 nm. The present invention encompasses each of the UV LEDs of 10-500 milliwatt (mW).

In some embodiments, the UV LEDs are placed approximately 20 millimeter (mm) to about 40 mm apart from each other above the water fluid flow spiral path.

Referring to FIG. 21, ten (10) UV LEDs placement for disinfecting fluid according to an exemplary embodiment are shown. As can be seen, 10 UV LEDs (A, B, C, D, E, F, G, H, I, and J) are placed on the casing. Following from UV LED A, a water spiral path is shown through these UV LEDS from B-J using the dotted lines. As seen, the UV LED A is placed in almost the center of the casing. UV LEDs D and E are placed almost above the UV LED A and UV LEDs B, I, H, G are placed below the UV LED A. UV LED F is placed almost to a right side of the UV LED A and UV LED C and J are placed towards the left side of the UV LED A.

In some embodiments, the UV LEDs (A, B, C, D, E, F, G, H, I, and J) Optical Power is 70 mW and the UV LEDs (A, B, C, D and E) wavelength is 265 nm.

In some embodiments, the UV LEDs are placed approximately 20 millimeter (mm) to about 40 mm apart from each other above water fluid flow spiral path.

In its simplest embodiment, a device 15 contains a single spiral fluid passage 5 connected with a fluid supply. However, in some embodiments, multiple spiral fluid passages 5 may be joined together. For example, FIG. 16 shows four spiral fluid passages joined in parallel to create an overall device 15 with a single inlet and multiple outlets. This configuration allows a device to disinfect more fluid or disinfect fluid at a fast rate. In another embodiment, and as shown in FIG. 17, a plurality of spiral fluid passages 5 may be joined in series. Specifically, FIG. 17 shows four spiral fluid passages 5 connected in series so as to have a single inlet and a single outlet for the whole device 15. This configuration allows a device to disinfect fluid at a faster flow rate or more completely. In another embodiment, a device may include some spiral fluid passages 5 connected in series, and some connected in parallel to build the overall device.

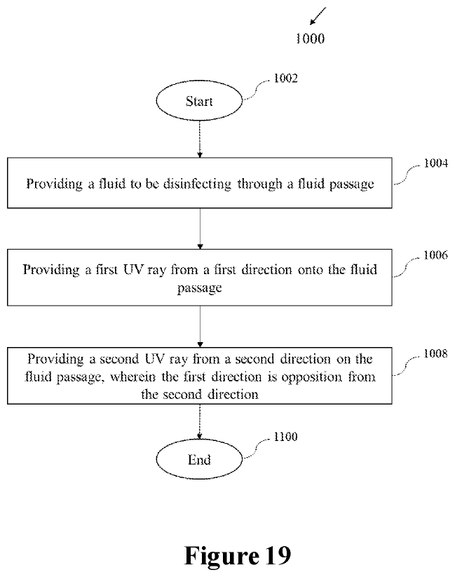

Referring to FIG. 19, a method flow diagram 1000 for disinfecting fluid according to an exemplary embodiment is shown. The method flow diagram 1000 starts at step 1002. At step 1004, a fluid to be disinfecting is provided through a spiral fluid passage 5. At step 1006, a first UV ray from a first direction is provided onto the spiral fluid passage. At step 1008, a second UV ray from a second direction is provided on the spiral fluid passage 5. Further, the first direction is opposition from the second direction. All these steps are explained above in greater detail.

Moreover, the first UV ray and the second UV ray each has a wavelength between about 265 nm to about 280 nm.

The advantageous design according to embodiments of this disclosure as compared to conventional designs is shown in an example that will be described in more detail herein.

A computational fluid dynamics (CFD) study was used to predict the log reduction value (LRV) for the spiral flow UV module according to an embodiment herein and a conventional double pass straight flow UV module.

A single UV-LED was used as the source of UV radiation and positioned at a center on a wall opposite to the respective inlets in both modules. The CFD results are tabulated in Table 1 below.

TABLE 1

| | | | | Radiation | | |
|---|---|---|---|---|---|---|
| | | | | flux at UV | Average | |
| | | Number of | Length of | LED | flow | LRV |
| UV Module | Flow rate | UV LED | liquid flow | surface/ | velocity | predicted |
| type | (LPM) | used | path | mA2 | (m/s) | by CFD |
| Spiral flow | 3 | 1 of 60 mW | 352 mm | 4899 | 0.5 | 1.9 |
| Double pass | 3 | 1 of 60 mW | 352 mm | 4899 | 0.5 | 1.4 |
| straight flow | | | | | | |

Considering the same flow path length, similar flow volume, and similar optical energy inputs, the CFD study showed that the spiral configurations according to embodiments herein described achieved a higher LRV.

In the double pass, straight flow device (comparative), low UV radiation intensity was observed in most of the region, the UV dose is non-uniform, and the UV intensity in the inlet section is less than in most of the regions. Whereas in the spiral flow UV module, the UV radiation intensity is relatively high, and uniform as shown in FIG. 8. The UV radiation intensity is efficiently utilized in the spiral flow UV module. As shown specifically in FIG. 8, UV radiation dose variation inside the fluid flow passage 5 of the inventive example (spiral flow) is shown. The UV radiation dose pattern shows maximum fluid passage volume coverage inside the experimental device that also explains the effectiveness of the UV disinfection device 15. In the UV disinfection device 15, uniform UV radiation intensity up to 70 J/m2 (Joule per meter square) is achieved. The spiral fluid flow passage can be provided in tube form or the spiral guide enclosure can be built into the inside casing. To make the passage quartz glass, a partition can be used inside spiral and circular flow UV module casing.

Further, no flow separation is observed inside the spiral flow passage, as shown in FIG. 9, a flow velocity pattern inside fluid flow passage 5. An average flow velocity of ˜0.5 m/s is achieved.

In further a test performed in a lab on the UV disinfection device 15 of the present invention, bacteria, virus such as E Coli, Micrococcus luteus and T1 Coliphage were added to the fluid. Table 2 below shows that approximately 99.9% E Coli were removed by disinfecting the fluid when the fluid is passed to a single reactor UV disinfection device 15.

TABLE 2

| Flow (gallon per | | |
|---|---|---|
| meter (gpm)) | ΔLOG | % Removal |
| 0.75 | 3.59 | 99.975 |
| 1 | 3.91 | 99.988 |
| 1.5 | 3.20 | 99.937 |

Table 3 below shows that approximately 99.99999% Micrococcus luteus were removed by disinfecting the fluid when the fluid is passed to a single reactor UV disinfection device 15.

TABLE 3

| Flow (gpm) | ΔLOG | % Removal |
|---|---|---|
| 0.53 | 7.06 | 99.999991 |
| 0.75 | 6.77 | 99.999983 |

Table 4 below shows that approximately 99.999% Micrococcus luteus were removed by disinfecting the fluid when the fluid is passed to three reactors UV disinfection device 15 connected in series.

TABLE 4

| Flow (gpm) | ΔLOG | % Removal |
|---|---|---|
| 2.5 | 5.45 | 99.999640 |

Table 4 below shows that approximately 99.99% T1 Coliphage were removed by disinfecting the fluid when the fluid is passed to a single reactor UV disinfection device 15.

TABLE 5

| Flow (gpm) | ΔLOG | % Removal |
|---|---|---|
| 1.5 | 4.13 | 99.993 |
| 2 | 4.28 | 99.995 |
| 2.2 | 4.26 | 99.995 |
| 2.5 | 3.54 | 99.971 |

Although the above testis performed only for a specific type of viruses and bacteria, however, test on other kinds of microorganism is also within the scope of this present invention.

The cleaning of the spiral flow passage inside the UV module casing can be simple. It merely requires opening the nuts and bolts or similar kind of connecting fitting, or back washing the device, which are known to the person skilled in the art. It provides a low cost solution and easy to clean options.

The UV module housing can be made of aluminum, stainless steel, or of any other sufficiently and strong material, such as metal, alloy, high-strength plastic. The various components of the UV-LED disinfection module can also be made of different materials.

Another variation of the fluid flow circulation passage can be circular flow, circular zigzag flow, spiral flow, square spiral flow, triangular Spiral flow, pentagonal spiral flow or elliptical spiral flow, or any other symmetric shape fluid flow passage design as shown in FIG. 17.

In an embodiment, the shape of UV module casing can be a flat circular disc shape or a flat plate shape.

The compact spiral flow UV module for fluid disinfection using an ultraviolet source can comprise one or more sensors, alarm controller, notification system and electronic control unit to receive and provide signals to user via wireless interoperability platforms. These can help users to monitor and control the UV disinfection device and to check its functioning and performance from a remote location using a mobile application.

In view of the embodiments disclosed herein, performance can significantly improve with flat spiral or circular flow passage geometry, UV LED position and UV radiation distribution inside the UV disinfection casing.

The device and method disclosed herein can be used for sterilization and disinfection of drinking water domestic reverse osmosis (RO), industrial RO system, or any point of use water system, food industry, pharmaceutical, biogas purification, central air conditioning ambient air disinfection, indoor air, waste liquid, or various other fluids of industries.

Specific embodiments of a compact ultraviolet fluid disinfection device and method according to the present disclosure have been described for the purpose of illustrating the manner in which the disclosure can be made and used. It should be understood that the implementation of other variations and modifications of this disclosure and its different aspects will be apparent to one skilled in the art, and that this disclosure is not limited by the specific embodiments described Features described in one embodiment can be implemented in other embodiments. The subject disclosure is understood to encompass the present disclosure and any and all modifications, variations, or equivalents that fall within the spirit and scope of the basic underlying principles disclosed and claimed herein.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the invention are set forth in the following claims.

1. A device for disinfecting fluid, comprising:
a first casing including a first at least one source of UV radiation;
a second casing including a second at least one source of UV radiation; and
a fluid passage provided in between the first casing and the second casing, wherein the UV radiation emitted from the first at least one source of UV radiation is directed toward the fluid passage from a first direction and the UV radiation emitted from the second at least one source of radiation is directed toward the fluid passage from a second direction that is different from the first direction.

2. The device of claim 1, wherein the fluid passage is provided in the form of a circular spiral fluid passage, a triangular spiral fluid passage, a hexagonal spiral fluid passage, a pentagonal spiral fluid passage, an octagonal spiral passage, or a rectangular spiral fluid passage.

3. The device of claim 1, wherein the first at least one source of UV radiation and the second at least one source of UV radiation are UV-LEDs.

4. The device of claim 1, wherein the first casing further comprises a first printed circuit board (PCB) including the first at least one source of UV radiation, and the second casing further comprises a second PCB including the second at least one source of UV radiation.

5. The device of claim 1, further comprises a first reflection plate positioned between the first casing and the fluid passage and a second reflection plate positioned between the second casing and the fluid passage.

6. The device of claim 1, further comprises a first heat sink coupled to an outer surface of the first casing and a second heat sink coupled an outer surface of the second casing.

7. The device of claim 1, wherein an inner surface of a first casing comprises a first UV-reflective finish and an inner surface of the second casing comprises a second UV-reflective finish.

8. The device of claim 17, wherein the inlet is connected to the fluid passage at a central portion of the fluid passage.

9. The device of claim 1, wherein the UV radiation emitted from the first at least one source of UV radiation and the UV radiation emitted from the second at least one source of UV radiation each have a wavelength between about 265 nanometer (nm) to about 280 nm.

10. The device of claim 1, wherein the first at least one source of UV radiation comprises one or more UV LEDs of 10-500 milliwatt (mW) each and placed approximately 20 millimeter (mm) to about 40 mm apart from each other above the fluid passage.

11. The device of claim 1, wherein the fluid is water.

12. A device for disinfecting fluid, comprising:
a first casing including a first plurality of UV-LEDs configured to emit UV radiation;
a second casing including a second plurality of UV-LEDs configured to emit UV radiation;
a fluid passage configured to accept a fluid provided in between the first casing and the second casing;
a first reflection plate between the first casing and the fluid passage;
a second reflection plate between the second casing and the fluid passage;
an inlet coupled to the first casing and is further connected to a first end of the fluid passage; and
an outlet coupled to the second casing and is further connected to a second end of the fluid passage,
wherein the fluid enters through the inlet, passes through the fluid passage, and exits through the outlet, and the UV radiation from the first plurality of UV-LEDs is directed toward the fluid passage from a first direction and the UV radiation from the second plurality of UV-LEDs is directed toward the fluid passage from a second direction that is opposite from the first direction.

13. The device of claim 12, wherein the fluid passage is a circular spiral fluid passage, a triangular spiral fluid passage, a hexagonal spiral fluid passage, a pentagonal spiral fluid passage, an octagonal spiral passage, or a rectangular spiral fluid passage.

14. A method of disinfecting fluid, comprising:
providing a fluid to be disinfecting through a fluid passage;
providing UV radiation from a first at least one source of UV radiation, wherein the UV radiation is emitted in a first direction onto the fluid passage; and
providing UV radiation from a second at least one source of UV radiation, wherein the UV radiation is emitted in a second direction on the fluid passage, wherein the first direction is opposition from the second direction.

15. The method of claim 14, wherein the UV radiation from each of the first and second at least one sources of UV radiation has a wavelength between about 265 nm to about 280 nm.

16. The method of claim 14, wherein the fluid passage is a circular spiral fluid passage, a spiral triangular fluid passage, a hexagonal spiral fluid passage, a pentagonal spiral fluid passage, an octagonal spiral fluid passage, or a rectangular spiral fluid passage.

17. The device of claim 1, wherein the first casing further comprises an inlet connected to the fluid passage, and the second casing further comprises an outlet connected to the fluid passage, wherein the fluid enters the fluid passage from the inlet, passes through the fluid passage, and exits the fluid passage via the outlet.
